(19) United States
(12) Patent Application Publication
(10) Pub. No.: US 2013/0258656 A1
(43) Pub. Date: Oct. 3, 2013

(54) Modulated LED light tube

(71) Applicant: Huei-Dung Chin, Taipei (TW)

(72) Inventor: Huei-Dung Chin, Taipei (TW)

(73) Assignee: huei-dung chin, Taipei (TW)

(21) Appl. No.: 13/110,949

(22) Filed: May 19, 2011

(51) Int. Cl. F21V 13/04

(52) U.S. Cl. CPC F21V 13/04
USPC 362/235

(57) ABSTRACT

The present disclosure generally relates a light tube assembly of a LED, especially the LED light tube with light modulation. Moreover, the LED light tube is similar to T8, T9 fluorescent lamp, which use at general lighting. Present disclosure proposes variants design for accomplishing light uniformity and efficiency, which proposes different features in light modulating in LED light tube assembly. The features include a reflection plate, reflector, secondary lens and LED dome lens shape etc. Present disclosure include a higher power of the LED device apply on the embodiment, which for complexity and cost reduction. In present disclosure, a variant type of power source feed in, where from the outside of the LED light tube, which could prolong the life of LED tube. Present disclosure further comprises variety features, which provide high efficiency and uniformity. Present disclosure preferably modulates LED light to batwing distribution.

### FIELD

The present disclosure generally related to a light emitting diode (hereinafter referred to as LED) light tube assembly, more particularly relate to a LED light tube, which similar with fluorescence tube lighting, such as T8, T9 light tube.

### BACKGROUND OF THE INVENTION

The LED used in general illumination had gradually found in the market, such as the replacement of the fluorescence tube or light bulb. LED used in the general lighting application had some advantages, such as long life time and high efficiency. And there are some of products in the markets, which for the replacement of T8, T9 light tube. However, the fluorescent lamps are the most popular in general lighting application. With relatively a low cost and much more efficient than incandescent lamp, the fluorescent lamp still had some advantages compare with LED light tube.

Please refer FIG. 1, which is a perspective view of the traditional LED light tube 100, which for replacement T8 light tube. In FIG. 1, a LED device 101 disposed on the surface of a PCB board 102. As the diagram, the LED devices 101 are arranged as a thread to form a stripe light. Whereon the LED device 101 disposed on the PCB board 102, and formed a LED board, which disposed on a metal frame 103 of the front surface.

Please refer the diagram, the front surface of the metal frame 103 further disposed a diffuser plate 104, and in the back of the metal frame 103, there is a hole in the back of metal frame 103, whereon a power converter 105 coupled in the hole of the metal frame 103.

And meanwhile, the power converter 105 connected to the PCB board 102, which provide the power source to the LED board. And at there both sides of the metal frame 103, which a plug 106 disposed on the metal frame 103 end of the both side, and connected electricity with the power converter 105, which can fed the electric power from the outside.

This is the traditional LED light tube assembly generally. However there are many problems in traditional LED light tube assembly. First of all, their used low current LED generally, which about 20 mA, which that will used a huge number of the LED device. For example, a 1200 mm long of replacement LED light tube, used almost over 300 pieces of 20 mA of LED. Too many LED devices may cause reliability issues from the complexity. In another hand, too many LED devices meant more expensive of the product.

For example, the material cost of LED package was similar with 20 mA of the LED die. When used so many of LED devices in the LED light tube structure, the cost of the LED devices, which would become a main issue.

Secondary, the traditional LED light tube design, which sometimes similarly fluorescent lamp character, the wild view angle. But in the reality, the LED devices must separate with a certain distances. In this situation, the LED light tube will has light spot on the thread, not similar with the fluorescent light tube.

Furthermore, the traditional LED light tube had fairly light strength at wild angle, in other hand the central of LED had relative higher than middle angle. This is the original LED light character, which the traditional design set the LED as a stripe light. In another word, the traditional LED light tube with no optical design in their assembly, just merely combine the objects without any further optimized the object.

Considering the other phase of the traditional LED light tube design, there the power converter 105 disposed on the back of the metal frame 103, which the power converter 105 held the all hemisphere of back of the metal frame 103 space. That will limited the LED optical design, and other feature performance, such as LED heat dissipation.

Furthermore, the power converter 105 dispose on the back of metal frame 103 cause another problem, power converter lift time. Because of traditional LED light tube generate quite a lot of heat, whereon the back of the metal frame 103 the power converter 105 will be heated. That will cause the power converter 105 decrease the lift time.

Although the traditional LED light tube structure, which power of consumption is one half the T8 light tube. Still the traditional fluorescent lamp has lower cost and quite a long lift time, when compare with traditional LED light tube design. So that the LED light tube need some advantages to compete with traditional fluorescent lamp. The best way is considering the overall owner cost, which means the LED light tube design needs more light efficiency, lift time and lower cost.

### SUMMARY

The present disclosure generally relates a LED light tube assembly, especially similar with the T8, T9 fluorescent lamp lighting. In present disclosure further comprise variant features to enhance the light efficiency and uniformity of the LED light tube. Further, in present disclosure propose variant power source, which could provide the design flexibility. And more, in one of present disclosure embodiment, which could use alternating current (AC) directly, for enhance the reliability and reduce the material cost.

In one embodiment of present disclosure, a LED device dispose on the surface of a circuit board, which using much more higher power then prior art, and form a LED circuit board. The LED circuit board disposes on the up surface of a tube base. A power source connect to a plug, which feed the electricity to the LED circuit board for provide the power electricity to the LED light tube.

In another one embodiment of present disclosure, a LED disposes on a PCB board, which the LED form a thread on the surface of the PCB board. A light reflection plate dispose on the front surface of the tube base, aside the LED circuit board, which for modulating the LED light distribution, such as convert to batwing light distribution. And a diffusible plate disposes on the outside of the LED light tube, which for scattering and re-distributing the light emit from the LED.

In another one embodiment of present disclosure, the LED devices dispose on a circuit board, which the LED devices form a thread and dispose on the surface of the circuit board. And then the LED circuit board, where disposes on a tube base. Further, a LED domed shape composes on the top surface of the LED to modulate the LED light in advance. A diffusible plate disposes on the up side of the LED light tube, whereon the edge of the LED light tube.

In another one embodiment of present disclosure, a LED dispose on the PCB board, which form a LED circuit board. The LED circuit board disposes on a tube case, whereon the edge of the tube case nearly. And a diffusible plate couple on the edge of the front of the tube base. The PCB board could further comprise a schematic for AC LED application, which for apply the AC power directly. Another way, a power converter disposes the one side of the tube base, when using this structure, whereon the one side, a case couple disposes to encapsulate the power converter.

In another one embodiment of present disclosure, a LED domed shape dispose on the LED. And then, a sunken cave disposes on the LED domed shape. Which form on the LED structure, and there be modulated the beam profile a batwing distribution. In another one of present disclosure, an AC power circuit propose, which comprise a rectifier, such as full wave rectification. The AC power through the rectifier, and pass a serial LED directly, without using power converter.

### BRIEF DESCRIPTION OF THE DRAWING

So that those have ordinary skill in art to which the subject disclosure, exemplary embodiments thereof will be described below the drawing, in which:

FIG. 1 is a perspective view of the prior art LED light tube.

FIG. 2 is a perspective view of present disclosure of the LED light tube.

FIG. 3 is a perspective view of another present disclosure of the LED light tube, wherein the LED surface with LED domed shape.

FIG. 4 is a cross-sectional view of another present disclosure of the LED light tube, whereon the LED top has a LED secondary lens.

FIG. 5 is a cross-sectional view of another present disclosure of the LED light tube, which with reflector on the LED.

FIG. 6 is a cross-sectional view of another present disclosure of the LED light tube, indirect lighting type of the LED light tube.

FIG. 7 is a diagram of present disclosure of the LED electric circuit, which for AC power operated directly.

FIG. 8 is a perspective view of present disclosure of the LED with domed shape.

FIG. 9 is a diagram of batwing light distribution of present disclosure.

FIG. 10 is other diagram of batwing light distribution of present disclosure.

### DETAIL DESCRIPTION

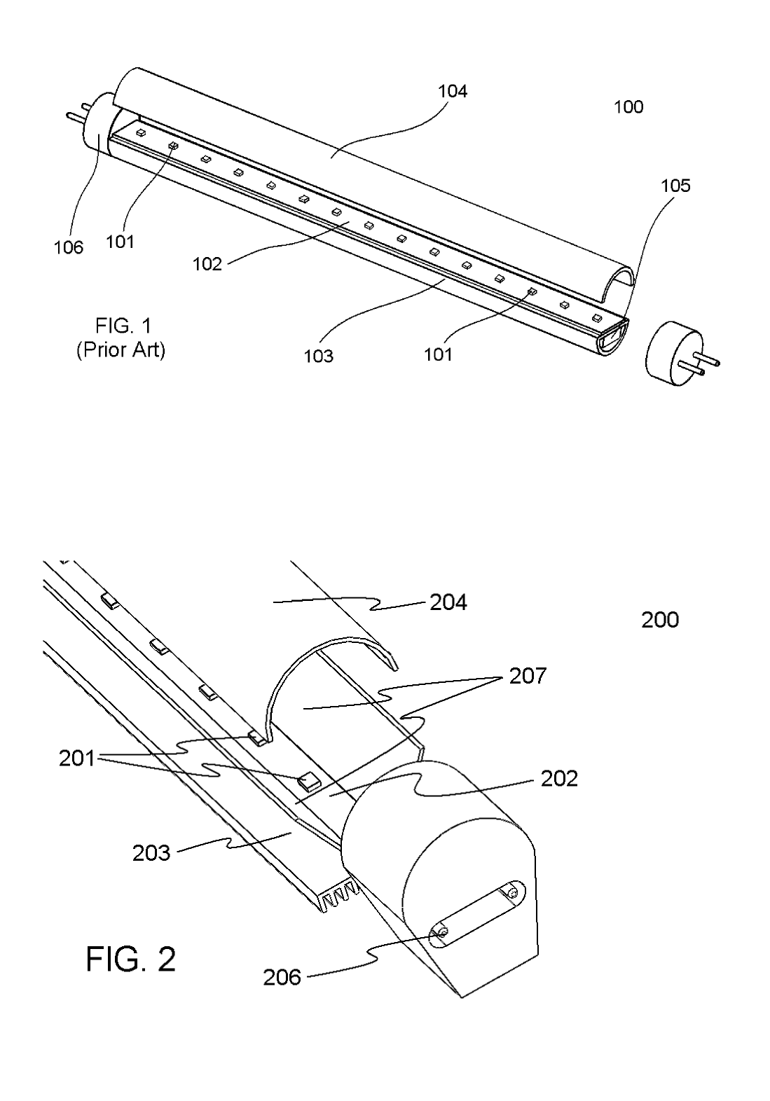

As show in FIG. 2, there is provided an embodiment of LED light tube 200, which in according with presenting disclosure. Referring to FIG. 2, which is a part of explore perspective view of the LED light tube 200 assembly. Please referring the FIG. 2, a LED devices 201 dispose on the surface of a circuit board 202, where the surface of the circuit board 202 with the electric scheme on their surface, which use for connecting all of the LED 201 with the proper electricity. The LED devices 201 couple to the circuit board 202, which form a LED circuit board. Furthermore the LED 201, whereon the circuit board 202 are arranged as a thread with a proper distances.

Furthermore, each the LED device 202 is operated at approximately 60 mA or above. That quite a different with prior art when design a LED light tube. And in present disclosure need more efficient heat dispersion in design. There easily understanding the circuit board 202 need has very low thermal resistance, also the LED device structure. So that, the circuit board can be metal core PCB (MCPCB), which the circuit board subtract material is metal, such as Aluminum. And the LED device structure also has low thermal resistance, such as, wherein include a heat slug under a LED die to enhance the heat dispersion.

Please refer to FIG. 2, the LED circuit board dispose on the front surface of a tube base 203. There is a light reflection plate 207, whereon the front side of the tube base 203, which on the up surface of the tube base 203, with a reflective planar surface. In general, the light reflection plate 207 is disposed on surface of the tube base 203, which forming the structure with low price process, such as reflective thin foil. A light modulation structure 207 dispose on the front side of the tube base 203, furthermore the light reflection plate 207 mount on the both side of the LED 201, which for modulate the light distribution of the light emit from the LED device 201.

As show in FIG. 2, a diffusible plate 204 couple to the fringe of the light reflection plate 207, whereon the LED light tube 100 topside. And a plurality plug 206 mount on both side of the LED light tube 100, which for connect to the socket of the out side, such as a power source (not show in figure).

In prior art the power source could be a AC-DC converter, which connect to the LED circuit board and provide proper power electricity, and where dispose on back of the tube base 203. Their also easily understand in present disclosure, which the power source can feed the power electricity form the outside of the LED light tube 200 as present disclosure (not show in figure). Through the plug 206, which for the power source feed in, and provide the proper power electricity to LED light tube 200.

In present disclosure, further comprising a plug (not show in figure), whereon dispose on the other side of the LED light tube 200, opposite the plug 206. Through the plug, plurality of the LED light tube 200 could connect each other. And then the power source can provide the power electricity to the plurality of the LED light tube 200 correspondingly.

According above of the present disclosure, the LED devices 201 are arranged as a stripe on the circuit board 202, their distances between each other can about over 20 mm or more distances. That means can save the numbers of the LED 201 used, which save material cost. In another hand, as drawing can sees the light modulation structure 207 is a reflection plate, which is a thin plate with high reflection coating, which mount on the lateral of the LED 201 individually.

That can modulate the LED 201 light distribution, which traditional application cannot afford. However, the present disclosure, the operation current of the LED devices 201 will up to 60 or higher, in traditional application light tube length. By considering the present disclosure, the reflection plate 207, which can modulate the LED light to become more efficiency or more uniformity. So, the present disclosure will be more efficiency than traditional design, and that means the current of the LED 201 will lower than predict, and so reduce the number of the LED device.

Accordingly, the tube case 203 composes by high conductivity material, such as aluminum, and which can form by protrusion process. As show in FIG. 2, the tube case 203 and the heat generate by the LED devices 201, which is dissipated by way of circuit board 202, and then through the tube case 203 exhaust to the outside.

The traditional design used the MCPCB, which want to reduce the thermal resistance of the PCB. Because of the LED light tube application in present disclosure, with high efficiency, and which LED device separate a quite distance, so that the total heat generation quite low, there could easily understand, the circuit board 202 also can use the very thin flexible, such as 1 mil FPCB to achieve the low thermal resistance.

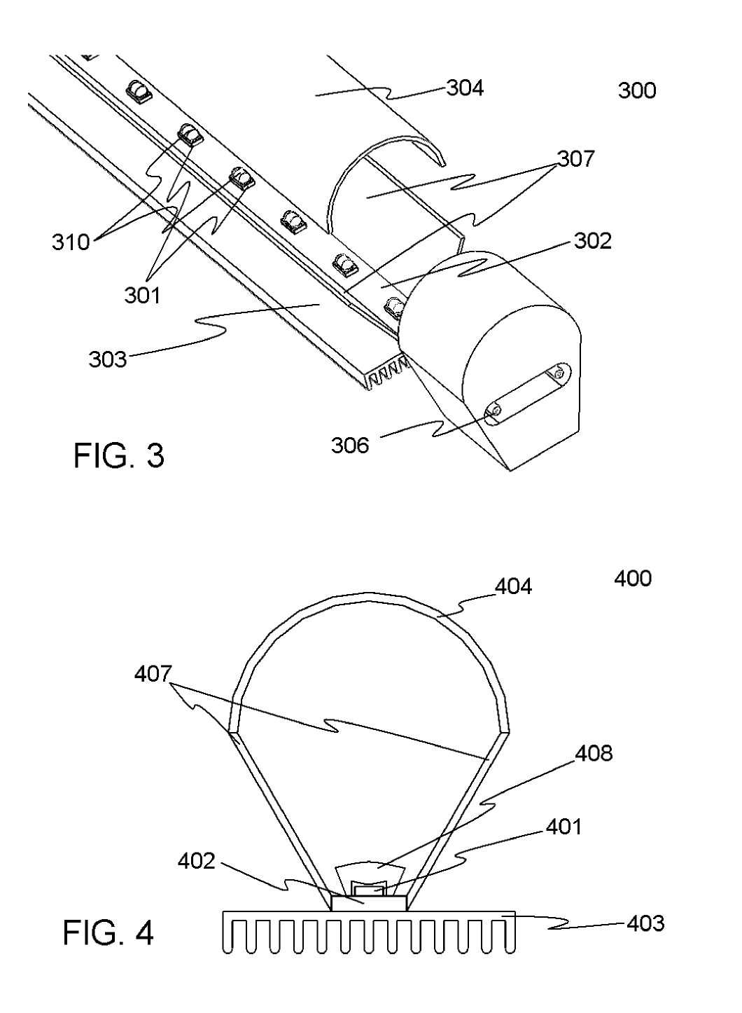

Please referring to FIG. 3, wherein is a part of explore perspective view of the LED light tube 200 assembly of another disclosure embodiment of the LED light tube assembly. The FIG. 3 is the explore perspective view of the LED light tube 300 of the present disclosure. A LED devices 301 disposes on a circuit board 302, which the LED devices 301 form a thread on the surface of the circuit board 302.

There will easily understanding, that the circuit board 302 can be MCPCB. And which above two features couple as a LED circuit board, and then dispose on a tube base 303. The material of the tube base 303 can be aluminum, same as above disclosure.

And then, a LED domed shape 310 composes on the top surface of the LED devices 301. In general, the LED devices 301 usually have a transparent dome at the top surface of the LED, which could be formed by molding or others processes. The LED with a domed shape lens, which can enhance the light extraction of the LED device, their also, can modulate the LED light distribution.

Please referring to FIG. 3, a diffusible plate 304 disposes on the up side of the tube base 303, whereon the edge of a light reflection plate 307. In the other hand, the light reflection 307 can modulate the light emit from the LED 301, and the light scatter by the diffusible plate 304 to form a light bar.

In traditional LED light tube designation, the LED light without any modulation, but only use diffuser, which function similarly the diffusible plate 304 do. Traditional LED light tube has some problems, such that the light uniformity of the two direction. According above problems, which can overcome the problems, by apply some appropriate light modulation design, such according in present disclosure.

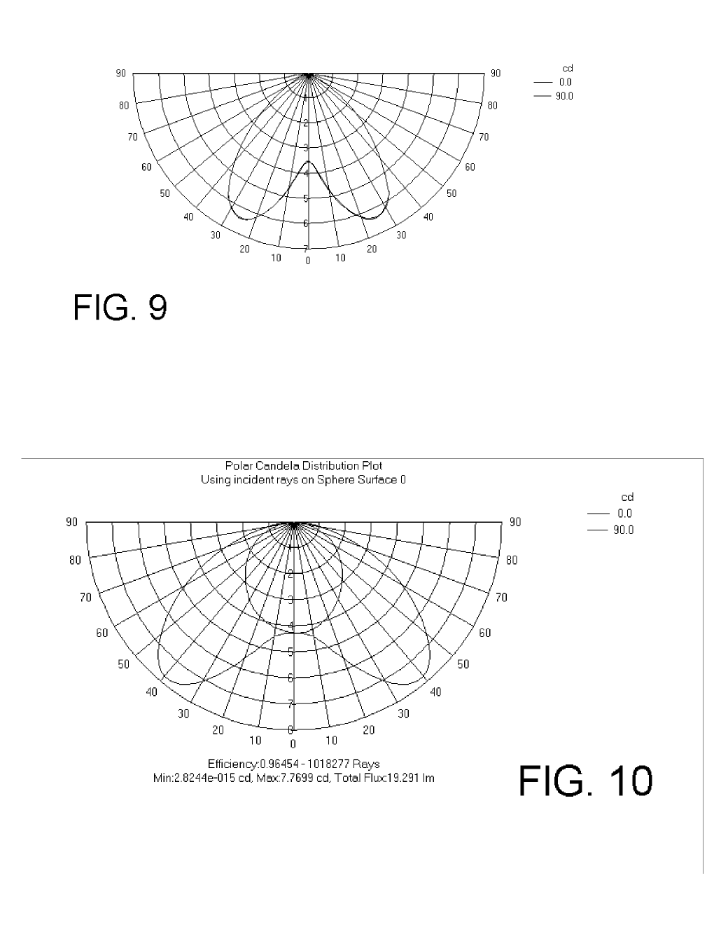

Furthermore, the LED domed shape 310, which designation can similar as FIG. 8. Please referring FIG. 8, there is perspective view of a LED 800 in present disclosure. As show in diagram, a LED 801 whereon the surface, which a LED domed shape 802 dispose on it. And then, a sunken cave 803 dispose on the LED domed shape 802. In above LED structure, there beam profile can become as FIG. 9 illustration, a batwing light distribution.

Please referring to the FIG. 3, whereon the domed shape 310 is not a hemisphere similar with the FIG. 8 show. The outline of the domed shape 310 as the FIG. 8 show, which look like as a half capsular transparent lens, and dispose on the LED device 301. That the domed shape 310 is dispose on the LED device 301, which the light emits from the LED device 301 also can modulate as a batwing distribution.

As FIG. 10 show, the batwing distribution in present disclosure is only one direction. In other direction, the beam profile is convergence. It's easily understand that in present disclosure, the domed shape 310 can modulate the LED devices 301 light become variant light distributions, which depends as system required.

Furthermore, the present disclosure in FIG. 3, the light reflection plate 307 can also modulate the light emit from the LED device 301. That can understand easily, the direction of convergence profile modulate by the domed shape 310, could be modulate by the light reflection plate 307 as a batwing distribution.

There are two directions, the longitudinal and horizontal, which in present disclosure of embodiment. The longitudinal direction, such as in FIG. 3 diagram, which means the direction of the thread of the LED direction. And from right to the left in the diagram, which can be as the horizontal direction. In traditional design, the uniformity of the light in two directions, the fluorescent lamp even can't achieve it.

In present disclosure of the embodiment, the batwing light distribution which modulate by the variant features from the above disclosure, that can possess a fairly uniformity of the LED light, which the traditional design can't achieve. And more, from present disclosure above, there further possess the light efficiency through the LED light modulation.

In traditional LED light tube 300, which illumination will not so uniform, because of without optical design for the light tube. So that the traditional let light tube design will cause some problem. For example, using the traditional LED light tube in the office, non-uniformity of the LED light tube 300 will made some area too bright and some of area too dark, whereon the area of illumination. And considering traditional light tube design drawbacks, the present disclosure have varied optical design, which for overcome above problems. And there can easily understand, the light tube illumination of the two directions can possess high efficiency and uniformity separately, through the different light modulation design.

As the diagram of the light distribution illustrate of the FIG. 9, the batwing light distribution, which the central light intensity—the zero degree, which is not the most strength of the light intensity. Generally, the LED light tube 300 has uniform illumination lighting, which means the LED light tube 300 of illumination is uniformly in active area. And the batwing light distribution, as show in the FIG. 9, which at 25 degree has the most intensive strength of the light, and that can compensate the wild angle of the illumination, which let the active area with uniform lighting. That is why in present disclosure, the LED light tube 300, which light distribution is batwing shape preferably.

Especially, the present disclosure of the LED light tube of the light distribution, which using the optical design modulate the LED light as batwing distribution preferably. That can easily understanding, the batwing distribution can overcome the LED non-uniformity in application, and provide a quite large area of illumination uniformly. In another hand, the present disclosure, which also provides a uniform light in longitudinal direction, which means the light stripe show at the diffusible plate surface, which looks like continuous light stripe, which is traditional design can't achieve it.

Generally speaking, the LED light distribution is a Lambertian distribution naturally. This light distribution is well known as person having ordinary skill in the art. Because of the LED light emitting area is relative small, so that whenever apply on the LED light bar that will cause non-uniformity. As present disclosure above, the LED domed shape 310 can be used to modulate the LED light to become a batwing distribution or others. That will easily understand, the function of the reflection plate 307, can totally replace by the LED domed shape 310.

As referring above, the present disclosure, which the embodiment possesses high efficiency, and also has high uniformity, which by properly optical design. Furthermore, which varied features as disclose above, which all could modulate the LED light distribution. Such that could easily understand, whether the LED domed shape 310 may with sunken cave or not, that depend on the optical design.

Please referring to FIG. 4, there are a cross sectional view of another disclosure embodiment of the LED light tube assembly. The FIG. 4 is a LED light tube 400 of cross sectional view of the present disclosure. A LED devices 401 disposes on a circuit board 402, which the LED devices 401 form a thread on the surface of the circuit board. And which two features couple as a LED circuit board, and then dispose on a tube base 403.

As show in FIG. 4, there still has a light reflection plate 407 dispose on the tube base 403 structures. A diffusible plate 404 disposes on the up side of the tube base 403, whereon the edge of the light reflection plate 407. Please referring the diagram, the present disclosure further has a secondary lens 408 dispose on the LED device 401.

As above disclosure, when LED light tube 400 operate, the light emit from the LED device 401 is modulated by the secondary lens 408 and the light reflection plate 407 properly, and then propagate to the diffusible plate 404. The light is scattering by the diffusible plate 404, and penetrates through the diffusible plate 404, and the light emit out of the LED light tube 400.

Their easily understanding, the LED light tube 400 still has a plug device (not show in this diagram) to couple the power electricity from the out side of the LED light tube 400. That the structure same as above disclosure. And so, their power source that feed in plug device still can be the AC-DC converter.

As the diagram show, the present disclosure embodiment has the secondary lens 408, which has different with the FIG. 3. Considering above, the present disclosure of embodiment possess the high efficiency and high uniformity, which the optical design need to converge the LED light. Furthermore, the optical design could let the light distribution of the LED become convergence and possess batwing distribution more precisely, when the LED light tube of the light distribution, which possess high uniformity.

So that it is easily understand that the function of the secondary lens 408 similarly like the light modulation structure as above disclose but more precisely. Moreover, the secondary lens 408 is disposed on the LED device 401 respectively. So that could understand easily, the secondary lens 408 could possess different shape in the LED light tube 400 to modulate different light distribution, whenever required.

And then the light reflection plate 407, which function can also replace by the light modulation structure, the light reflection plate 407 also enhance the LED light modulation, although the light reflection plate 407 can hardly modulate the light of the longitudinal direction. In conclusion, the present disclosure of the light modulation features, as propose above, which could apply simultaneously, whenever required.

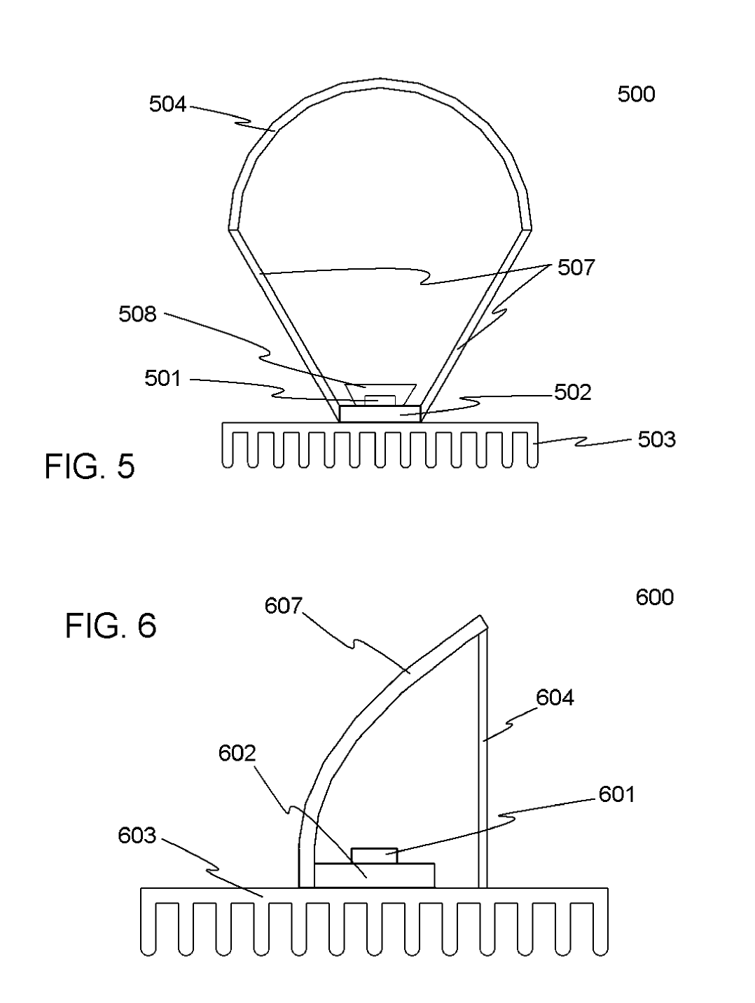

Please referring to FIG. 5, there are a cross sectional view of another disclosure embodiment of the LED light tube assembly. The FIG. 5 is a LED light tube 500 of cross sectional view of the present disclosure. A LED 501 disposes on a PCB board 502, which the LED 501 form a thread on the surface of the PCB board. And which two object couple as LED circuit board, and then dispose on a tube base 503. In general, the LED 501 usually has a transparent dome at the top surface of the LED (not show in diagram). In general, the LED hemisphere dome shape can enhance the LED light extraction, but only used at the higher power LED.

Please referring to FIG. 5, there are a cross sectional view of another disclosure embodiment of the LED light tube assembly. The FIG. 5 is a LED light tube 500 of cross sectional view of the present disclosure. A LED devices 501 disposes on a circuit board 502, which the LED devices 401 form a thread on the surface of the circuit board. And which two features couple as a LED circuit board, and then dispose on a tube base 503.

As show in FIG. 5, there still has a light reflection plate 507 dispose on the tube base 503 structures. A diffusible plate 404 disposes on the up side of the tube base 503, whereon the edge of the light reflection plate 507. Please referring the diagram, the present disclosure further has a light reflector 408 dispose on the LED device 501.

As above disclosure, when LED light tube 500 operate, the light emit from the LED device 501 is modulated by light reflector 508 and the light reflection plate 507 properly, and then propagate to the diffusible plate 504. The light is scattering by the diffusible plate 504, and penetrates through the diffusible plate 504, and the light emit out of the LED light tube 500.

It's also easily understand, which the light reflector 508 possess variant shape, such as figure can be a conical shape, elliptic, parabolic or special optical design etc., or for special request of design. And which the surface of the light reflector 508, could be coated with high reflection materials for enhance the LED light reflection. The present disclosure of the light reflector 508 also could be low cost materials, such as high reflective metal foil or plastic.

According above describe, in present disclosure, there are several methods can modulate the LED light distribution, such the light reflector 508, the secondary lens 408, the LED dome shape 310 or the light reflection plate 207, that all can modulate the LED light distribution. There easily understanding, which can combine two or more of the features as above disclosure, to accomplish the light distribution requirement of the LED light tube.

Further referring to FIG. 6, which is a cross sectional view of another LED light tube 600 assembly of disclosure embodiment. The FIG. 6 is a LED light tube 600 of cross sectional view of the present disclosure, which for in-directional lighting. Indirection lighting, which means the light emit from the LED device do not illuminate the target (or object) directly.

In present disclosure, a LED device 601 disposes on a circuit board 602, which the LED device 601 form a thread on the surface of the circuit board similar with above disclosure. And which two object couple as LED circuit board, and then dispose on a tube base 603. In general, the tube base 603 is made as high thermal conductivity materials such as Aluminum. And also at back side of the tube base 602 has fin structure, which for increasing the surface area to enhance the heat dissipation capacity.

As show in FIG. 6, there still has a light reflection plate 607 dispose on the tube base 603 structures. Please referring the diagram, the light reflection plate 607 has a curve shape and the surface extend over the LED device 601 of the emitting surface. That means the light from the LED device 601 will redirect by the light reflection plate 607.

A cover plate 604 disposes on the up side of the tube base 603, whereon the other edge of the light reflection plate 607. Because of the light path of the from the LED device 601 to the cover plate 604 could be quite a long distance. So the function of cover plate 604 could different with the diffusible plate, such as only provide dust prevent. That could easily understand, the cover plate 604 could take out without influence the lighting character.

In present disclosure also could easily understand, which could further dispose a light modulation features on the LED device 601, and enhance the light modulation capacity. And also could combine one or two the light modulation features, where dispose in the LED light tube 600.

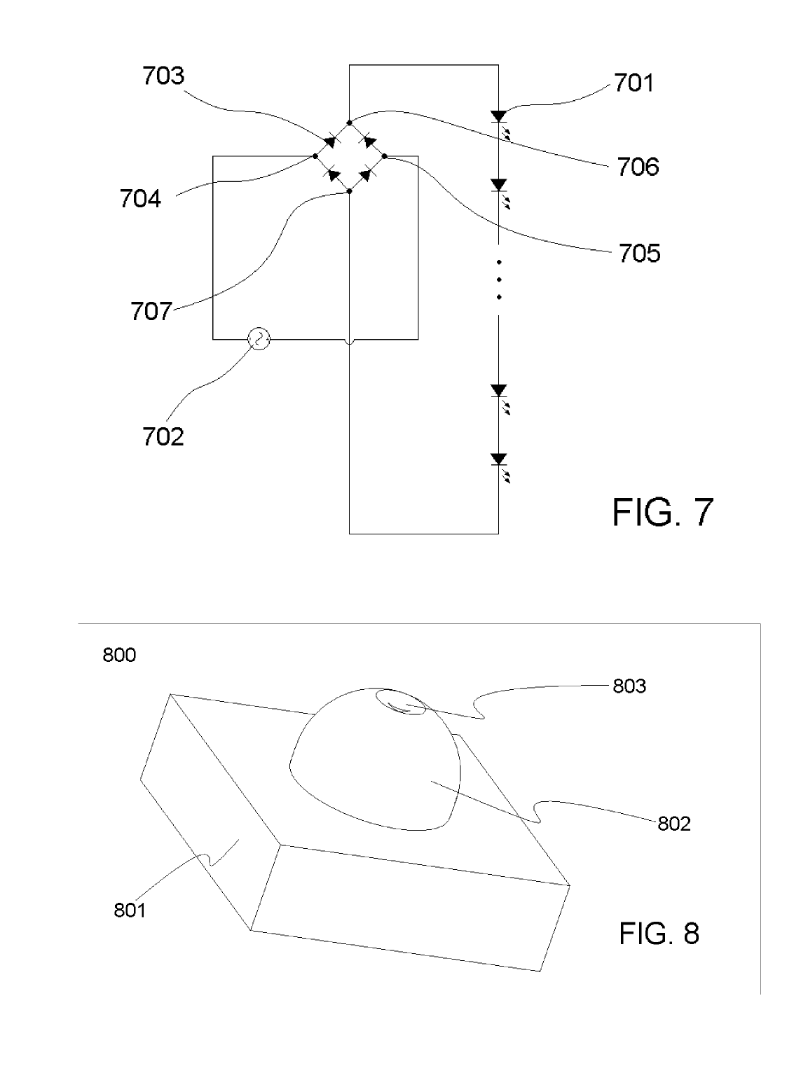

According the present disclosure, the LED circuit board can feed the AC power directly, which one of the schematic on the circuit board 602 can be similar FIG. 7. As show in FIG. 7, an AC power 702 connects to a rectifier 703. As diagram show, the rectifier 703 has four diodes and with four nodes (terminals). Please referring the diagram, a node 704 and 708 each connect to the two of the terminals of the AC power 702. In general, which the application of the full wave rectifier with a large capacitor, but in present disclosure of the embodiment don't need the capacitor at all.

As show in diagram, a plurality LED 701 connects each other serially, and which the LED 701 of two terminals connects a node 706 and 707 respectively. In general, the LED 701 which can by using series circuit properly, to make LED circuit can operate the AC power directly. For example, when operate directly under voltage AC 110, it will might connects about 35 to 40 LED devices. There are some patents describe about AC LED application, although all about chip-level application, but it is easily understanding, that all can apply in this embodiment.

And there must be known, in present disclosure, the LED light distribution or the batwing light distribution, which means the light distribution of the LED light tube, and the light project on the target such as ground or desk, which form the LED light tube emitting. For example, when considering the horizontal light projection of the light distribution of the LED light tube, that can exploit the present disclosure objects or their combination to achieve these requirements, such as high efficiency and/or uniformity. And at the other direction, the longitudinal direction, which could possess other type of the light distribution, but there still can achieve the uniformity, although need comprehensive optical design.

Skills are familiar with this area, though the writing better clarify the above examples, however, its not to limit the creative spirit. Not out of the creative spirit and scope of the changes made and similar in configuration, should be included in the below of claim within, this range should cover all such changes and a similar structure, and should make the most broad interpretation.

What is claim is:

1. A LED light tube, comprising:
a circuit board, which the circuit scheme are disposed on the circuit board, and thermal resistance of the circuit board is properly low;
a plurality of LED devices, which has a heat slug for heat dispersion under the LED die and connect to the circuit board, and the LED devices are located as thread line and separated with adapted distance, and which the current of each the LED devices is operated approximately 60 mA or higher;
a tube base, which is made by high thermal conductivity material, whereon the tube base with a planar surface for adopted the circuit board;
a light reflection plate, which dispose on the tube base, where aside the circuit board, and the light reflection plate with high reflective surface, which could modulate the light emit from the LED devices;
a diffusible plate, which dispose on the edge of the LED light tube, and opposing the circuit board and the LED devices, which for dispersing the light emit from the LED devices;
a one or plurality of plugs, which for electric power feed in the LED light tube;
a power source, which provide the electrical power from the outside of the LED light tube, the power source can be a AC-DC converter which provide electricity through the plugs to the LED light tube, and light the LED light tube properly; and
the diffusible plate, wherein dispose on the LED device with a proper separated distance, when lighting the LED light tube, which emitting light from the LED device pass through the surface of the diffusible plate, which the surface of the diffusible plate are formed as a light stripe uniformly, that make the human eyes will see the light stripe without any light spot or discontinuity.

2. The LED light tube of claim 1, wherein the circuit board is made as high thermal conductivity material, such as Al or copper, or a FPCB, which has a thickness approximately 1 mil. alternatively.

3. The LED light tube of claim 1, wherein the light reflection plate is made by high reflective metal foil or plastic thin plate, and the light reflection plate could further include high reflective coating to enhance light efficiency or include a curved shape to enhance the light modulation.

4. The LED light tube of claim 1, wherein the LED devices which emitting surface further comprising a transparent dome shape as a light modulation apparatus, which to converge the light emit from the LED devices and/or the light modulation apparatus include a specific dome shape such as a dent shape on the top of the transparent dome shape to the modulated the light emit from the LED device as batwing distribution.

5. The LED light tube of claim 1, wherein the LED devices further mount a light reflector or a secondary lens as a light modulation apparatus, to converge the light emit from the LED devices and/or modulated the light emit from the LED devices as batwing distribution.

6. The light modulation apparatus of claim 10, which could include the LED dome shape, reflector and the secondary lens, combine above two or all the apparatus, to converge the light emit from the LED devices and/or modulated the light emit from the LED devices as batwing distribution in advance.

7. The LED light tube of claim 1, wherein the power source is AC power electricity, with the circuit board is designed and electrical device disposed on properly, which the AC power electricity from the grid could feed in the LED light tube directly.

8. A uniform LED light tube, comprising:
a circuit board, which the circuit scheme are disposed on the circuit board, and thermal resistance of the circuit board is properly low;
a plurality of LED devices, which has a heat slug for heat dispersion under the LED die and connect to the circuit board, and the LED devices are located as thread line and separated with adapted distance, and which the current of each the LED devices is operated approximately 60 mA or higher;
a light modulation apparatus, which dispose on the LED devices respectively, and modulate the light emit from the LED devices;
a tube base, which is made by high thermal conductivity material, whereon the tube base with a planar surface for adopted the circuit board;
a diffusible plate, which dispose on the edge of the LED light tube, and opposing the circuit board and the LED devices, which for dispersing the light emit from the LED devices;
a one or plurality of plugs, which for electric power feed in the LED light tube;
a power source, which provide the electrical power from the outside of the LED light tube, the power source can be a AC-DC converter which provide electricity through the plugs to the LED light tube, and light the LED light tube properly; and
the diffusible plate, wherein dispose on the LED device with a proper separated distance, when lighting the LED light tube, which emitting light from the LED device pass through the surface of the diffusible plate, which the surface of the diffusible plate are formed as a light stripe uniformly, that make the human eyes will see the light stripe without any light spot or discontinuity.

9. The uniform LED light tube of claim 13, wherein the circuit board is made by high thermal conductivity material, such as Al or copper, and also could be as FPCB, which thickness is about 1 mil or thinner.

10. The uniform LED light tube of claim 14, wherein the light modulation apparatus is disposed on the emitting surface of the LED devices, and further comprising a transparent dome shape as a light modulation apparatus, which to converge the light emit from the LED devices and/or the light modulation apparatus include a specific dome shape such as a dent shape on the top of the transparent dome shape to the modulated the light emit from the LED device as batwing distribution.

11. The uniform LED light tube of claim 14, wherein the light modulation apparatus further include a secondary lens or a light reflector, which dispose on the LED device to converge the light emit from the LED devices and/or modulated the light emit from the LED devices as batwing distribution.

12. The light modulation apparatus of claim 20, which the LED devices could apply the LED dome shape, reflector and the secondary lens, combining above two or all apparatus to converge the light emit from the LED devices and/or modulated the LED device light as batwing distribution in advance.

13. The uniform LED light tube of claim 14, wherein further include a light reflection plate, which is made by high reflective metal foil or plastic thin plate, and the light reflection plate could further include high reflective coating to enhance light efficiency or include a curved shape to enhance the light modulation.

14. The power source of claim 22, wherein the power source is AC power electricity, with the circuit board is designed and electrical device disposed on properly, which the AC power electricity from the grid could feed in the LED light tube directly.

15. A indirect lighting LED light tube, comprising:
a circuit board, which the circuit scheme are disposed on the circuit board, and thermal resistance of the circuit board is properly low;
a plurality of LED devices, which has a heat slug for heat dispersion under the LED die and connect to the circuit board, and the LED devices are located as thread line and separated with adapted distance, and which the current of each the LED devices is operated approximately 60 mA or higher;
a tube base, which is made by high thermal conductivity material, whereon the tube base with a planar surface for adopted the circuit board;
a light reflection plate, which dispose on the tube base has pre-design curve, where the surface of the light reflection plate reflect the light emit from the LED devices properly, and the light reflection plate with high reflective surface, which change the light propagation direction, which emit from the LED devices;
a one or plurality of plugs, which for electric power feed in the LED light tube;
a power source, which provide the electrical power from the outside of the LED light tube, the power source can be a AC-DC converter which provide electricity through the plugs to the LED light tube, and light the LED light tube properly; and
the diffusible plate, wherein dispose on the LED device with a proper separated distance, when lighting the LED light tube, which emitting light from the LED device pass through the surface of the diffusible plate, which the surface of the diffusible plate are formed as a light stripe uniformly, that make the human eyes will see the light stripe without any light spot or discontinuity.

16. The indirect lighting LED light tube of claim 25, wherein the light reflection plate, which is made by high reflective metal foil or plastic thin plate, and the light reflection plate could further include high reflective coating to enhance light efficiency or include a curved shape to enhance the light modulation.

17. The indirect lighting LED light tube of claim 25, whereon the LED devices which emitting surface further comprising a transparent dome shape as a light modulation apparatus, which to converge the light emit from the LED devices and/or the light modulation apparatus include a specific dome shape such as a dent shape on the top of the transparent dome shape to the modulated the light emit from the LED device as batwing distribution.

18. The indirect lighting LED light tube of claim 25, wherein the LED devices further mount a light reflector or a secondary lens, as a light modulation apparatus, to converge the light emit from the LED devices and/or modulated the light emit from the LED devices as batwing distribution.

19. The indirect lighting LED light tube of claim 25, wherein the light modulation apparatus which could include the LED dome shape, reflector and the secondary lens, combine above two or all the apparatus, to converge the light emit from the LED devices and/or modulated the light emit from the LED devices as batwing distribution in advance.

20. The indirect lighting LED light tube of claim 25, wherein the power source is AC power electricity, with the circuit board is designed and electrical device disposed on properly, which the AC power electricity from the grid could feed in the LED light tube directly.
